(19) United States
(12) Patent Application Publication
(10) Pub. No.: US 2014/0104842 A1
(43) Pub. Date: Apr. 17, 2014

(54) REFLECTING PLATE FOR FRESNEL LENS AND ILLUMINATION DEVICE

(71) Applicant: MINEBEA CO., LTD., Kitasaku-gun (JP)

(72) Inventors: Hiroya HOSHI, Fukuroi-shi (JP); Takashi EDAMITSU, Fukuroi-shi (JP)

(73) Assignee: MINEBEA CO., LTD., Kitasaku-gun (JP)

(21) Appl. No.: 14/041,619

(22) Filed: Sep. 30, 2013

(30) Foreign Application Priority Data
Oct. 12, 2012 (JP) 2012-227081

(51) Int. Cl. F21V 13/04

(52) U.S. Cl. CPC F21V 13/04
USPC 362/277

(57) ABSTRACT

There is provided a reflecting plate for a Fresnel lens arranged between the Fresnel lens and a light source, the reflecting plate including: a concave reflecting surface to reflect light emitted from the light source toward the Fresnel lens; a unit to position the light source, the unit being provided at a bottom of the concave reflecting surface; and a unit to position the Fresnel lens, the unit being provided at an open end on a side opposite to the bottom of the concave reflecting surface.

### BACKGROUND OF THE INVENTION

1. Field of the Invention

The present invention relates to a reflecting plate used together with a solid light emitting element as represented by a light emitting diode and a Fresnel lens, and an illumination device having these components.

2. Description of the Related Art

In the past, it has been common to use incandescent lamps or fluorescent lamps as light sources for general illumination such as room illumination. However, with the recent high performance of blue light emitting diodes (LEDs), LEDs have also been used as light sources for downlights, spot lights, or the like (see, for example, JP-A No. 2012-119257). Since the LEDs consume less electric power and have longer service lives, they are suitable to respond to requests for the prevention of global warming and environmental conservation.

FIG. 6 exemplifies an illumination device 10 using an LED as a light source. The illumination device 10 is used as a spotlight. In the illumination device 10, a base 14 having spiral convexes 14a is fixed to a main body part 12 having a plurality of cooling fins 12a. In addition, a Fresnel lens 16 is fixed to the main body part 12. Moreover, a light source 18 having a plurality of LEDs 18a sealed by a sealing resin is fixed to a light source mounting surface of the main body part 12. Further, except for its light emitting part, the light source 18 is covered with a cover 20 fixed to the light source mounting surface of the main body part 12.

The Fresnel lens 16 has, for example, a plurality of zonal lenses 16a arranged in a concentric pattern. Here, the zonal lens 16a closer to an outside in the radius direction thereof is formed to deflect more light emitted from the light source 18 to the central side of the concentric pattern. The illuminating direction of the illumination device 10 can be thus fixed, and since the illumination device 10 is made thin and lightweight, it can contribute to the downsizing of the illumination device 10 (see, for example, JP-A Nos. 2012-119257 and 2012-114022).

### SUMMARY OF THE INVENTION

In order for the illumination device 10 to show the effects of the Fresnel lens 16 to a greater extent, it is necessary to make the light axis of the Fresnel lens 16 and that of light emitted from the light source 18 exactly correspond to each other. In addition, the Fresnel lens 16 plays a large role in adjusting the distribution of light emitted from the light source 18 such as the LEDs 18a and optimizing light irradiated from the illumination device 10. On the other hand, in some cases, light emitted from the light source 18 is absorbed into the Fresnel lens 16 causing reduction in the amount of light. This will eventually cause deterioration of the optical efficiency of the illumination device 10. In addition, since the Fresnel lens 16 is transparent, the wiring, components, and/or the like placed around the light source 18 are visible from the outside. This will deteriorate the appearance of the illumination device 10. Therefore, in the related art, the inner wiring or the like is shielded by a cover 20 so as not to be seen through via the transparent Fresnel lens 16. Marketability for the illumination device 10 can be thus maintained.

It is an object of the present invention to prevent the deterioration of an appearance in an illumination device using a Fresnel lens while optimizing irradiation lights.

The aspects of the present invention described below exemplify the structures of the present invention and are separately discussed to facilitate the understanding of the various structures of the present invention. Each aspect is not intended to limit the technical scope of the present invention. Even if some of the constituents of each aspect are replaced, deleted, or combined with other constituents in consideration of the best modes for carrying out the present invention, they may fall within the technical scope of the present invention.

(1) According to a first aspect of the present invention, there is provided a reflecting plate for a Fresnel lens arranged between the Fresnel lens and a light source, the reflecting plate including: a concave reflecting surface to reflect light emitted from the light source toward the Fresnel lens; a unit to position the light source, the unit being provided at a bottom of the concave reflecting surface; and a unit to position the Fresnel lens, the unit being provided at an open end on a side opposite to the bottom of the concave reflecting surface.

With this structure, the reflecting plate for the Fresnel lens allows reflecting lights, which is emitted in any other direction than the direction of the Fresnel lens out of light emitted from the light source, toward the Fresnel lens. This is because the concave reflecting surface of the reflecting plate for the Fresnel lens is arranged between the Fresnel lens and the light source. The reflecting plate for the Fresnel lens can thus efficiently reflect light emitted from the light source toward the Fresnel lens. As the concave reflecting surface, a cone-shaped curved surface may be formed.

In addition, the light source and the Fresnel lens are, respectively, positioned by the unit to position the light source provided on the bottom of the concave reflecting surface and the unit to position the Fresnel lens provided at the open end on the side opposite to the bottom of the concave reflecting surface. That is, the light source and the Fresnel lens are positioned via the reflecting plate for the Fresnel lens, which makes the light axis of the Fresnel lens and that of light emitted from the light source exactly correspond to each other.

(2) In the first aspect, the reflecting plate further includes: an opening formed in the bottom of the concave reflecting surface to allow light emitted from the light source to pass through, wherein the unit to position the light source has concave and convex portions having respective concave and convex configurations complementary to an outer shape of the light source and contactable with the light source so as to surround the opening, the concave and convex portions being arranged on a surface of the bottom of the concave reflecting surface on a side opposite to a side where the Fresnel lens is arranged, and the unit to position the Fresnel lens has concave and convex portions having respective concave and convex configurations complementary to an outer shape of the Fresnel lens and contactable with the Fresnel lens so as to surround the open end on the side opposite to the bottom of the concave reflecting surface.

In the reflecting plate for the Fresnel lens according to this aspect, an opening allowing light emitted from the light source to pass through is formed at the bottom of the concave reflecting surface of the reflecting plate for the Fresnel lens. The unit to position the light source is arranged at the bottom surface of the concave reflecting surface on the side opposite to the side where the Fresnel lens is arranged. The unit then allows positioning the light source. That is, the light source is positioned to the reflecting plate for the Fresnel lens with the concave and convex portions having the respective concave and convex configurations that are complementary to the outer shape of the light source. Further, the concave and convex portions are also arranged to be contactable with the light source. Also, the concave and convex portions are configured to surround the opening provided on the bottom surface of the concave reflecting surface opposite to the side where the Fresnel lens is arranged.

As an example, if a COB (Chip on Board) type LED is used as the light source, the concave and convex portions having the respective concave and convex configurations complementary to the outer shape of a ceramic substrate constituting the COB type LED are formed so as to surround the opening on the surface (rear surface) of the bottom of the concave reflecting surface on the side opposite to the side where the Fresnel lens is arranged. In addition, if the concave and convex portions are frames having a dimension that allows being smoothly press-fitted into the ceramic substrate, the light source is not only positioned to the reflecting plate for the Fresnel lens but also temporarily fixed to the reflecting plate for the Fresnel lens at the same time. Moreover, if the reflecting plate for the Fresnel lens is made of a non-transparent material, inner wiring can be covered and prevented from being seen through from outside via the Fresnel lens.

The unit to position the Fresnel lens is arranged at the position surrounding the open end provided on the side opposite to the bottom of the concave reflecting surface. The unit then allows positioning the Fresnel lens. That is, the Fresnel lens is positioned to the reflecting plate for the Fresnel lens with the concave and convex portions having the respective concave and convex configurations complementary to the outer shape of the Fresnel lens. Further, the concave and convex portions are also arranged to be contactable with the Fresnel lens. Also, the concave and convex portions are configured to surround the open end provided on the side opposite to the bottom of the concave reflecting surface.

As an example, arc-shaped positioning collar parts may protrude from a part of the periphery of the Fresnel lens. The concave and convex portions complementary to the outer shape of the Fresnel lens are then formed as the unit to position the Fresnel lens. The concave and convex portions are configured to surround the open end provided on the side opposite to the bottom of the concave reflecting surface.

Thus, the light source and the Fresnel lens are positioned via the reflecting plate for the Fresnel lens, which makes the light axis of the Fresnel lens and that of light emitted from the light source exactly correspond to each other.

(3) In the first aspect, the concave reflecting surface has a reflecting direction adjustment unit to reflect light emitted from the light source in a prescribed direction.

The reflecting plate for the Fresnel lens according to this aspect receives light emitted from the light source at the concave reflecting surface and reflects the same in a prescribed direction with the reflecting direction adjustment unit provided on the concave reflecting surface. Compared with the concave reflecting surface having a curved surface or an inclined surface on which no concave and convex configuration is intentionally provided, the concave reflecting surface with the reflecting direction adjustment can more properly reflect light, which is emitted in any direction other than the direction of the Fresnel lens out of light emitted from the light source, toward the Fresnel lens. Then, by harmonizing the reflecting effects of light with the reflecting direction adjustment unit and the polarizing effects of the Fresnel lens, further improvement for the adjustment of the distribution of light and optical efficiencies is expected.

(4) In the first aspect, the reflecting direction adjustment unit is a prism.

The reflecting plate for the Fresnel lens according to this aspect receives light emitted from the light source at the concave reflecting surface and reflects the same in a prescribed direction with the front surface (inclined surface) of the prism provided on the concave reflecting surface. Further, the concave reflecting surface more properly reflects light, which is emitted in any other direction than the direction of the Fresnel lens out of light emitted from the light source, toward the Fresnel lens. Then, by harmonizing the reflecting effects of light with the prism and the polarizing effects of the Fresnel lens, further improvement for the adjustment of the distribution of light and optical efficiencies is expected.

(5) In the first aspect, the reflecting plate is made of a material having a high reflectance.

Since the reflecting plate for the Fresnel lens according to this aspect is made of a material having a high reflectance, it receives light emitted from the light source at the concave reflecting surface and reflects the same in a prescribed direction with a high reflectance based on the reflecting effects of light. Further, the reflecting plate for the Fresnel lens more properly reflects light toward the Fresnel lens while preventing the leakage of light emitted other than the direction of the Fresnel lens out of light emitted from the light source. Thus, the reflecting plate for the Fresnel lens efficiently directs light emitted from the light source to the Fresnel lens.

(6) In the first aspect, the material having the high reflectance is one of a polycarbonate resin and an ABS (Acrylonitrile Butadiene Styrene) resin.

The reflecting plate for the Fresnel lens according to this aspect uses one of the polycarbonate resin and the ABS resin as the material having the high reflectance. Here, a white-colored resin is particularly preferable. Further, through the application of such materials, it is possible to manufacture the reflecting plate for the Fresnel lens by, for example, an ejection molding.

(7) In the first aspect, the reflecting plate further includes: a front surface layer made of the material having the high reflectance; and a substrate layer made of a material different from the material of the front surface layer.

The reflecting plate for the Fresnel lens according to this aspect receives light emitted from the light source at the concave reflecting surface via a material having a high reflectance constituting the front surface layer. The reflecting plate then allows reflecting light in a prescribed direction with the high reflectance through the reflecting effects of light. In addition, with the substrate layer made of a material different from that of the front surface layer, the strength of the reflecting plate for the Fresnel lens is assured. In this case, the substrate layer does not require a high reflectance. Therefore, it is possible to allow more selectabilities for materials and to provide additional function to the substrate layer besides reflectance properties.

For example, the substrate layer serving as a frame including the unit to position the light source or the unit to position the Fresnel lens is made of a synthetic resin such as a polycarbonate resin and an ABS resin. Further, it is possible to employ a two-layer structure in which the front surface layer having an aluminum plate or the like fixed thereto is integrated to cover the substrate layer. In addition, in order to improve the strength of the reflecting plate for the Fresnel lens, it is possible to employ a three-layer structure in which a metal layer serving as a reinforcing layer is embedded inside the front surface layer made of a synthetic resin. Moreover, in order to efficiently radiate heat from the light source via the reflecting plate for the Fresnel lens, it is possible to employ a multi-layer structure having a heat radiation layer. Further, any of these multi-layer structures is appropriately selected in consideration of the size, thickness, weight, strength, wall thickness, radiation performance, or the like of the reflecting plate for the Fresnel lens.

(8) In the first aspect, a surface treatment is applied to the concave reflecting surface for increasing the reflectance.

The reflecting plate for the Fresnel lens according to this aspect is subjected to the surface treatment which is applied to the concave reflecting surface for increasing the reflectance properties. Therefore, the reflecting plate for the Fresnel lens receives light emitted from the light source at the concave reflecting surface and reflects the same in a prescribed direction with a high reflectance through the light reflecting effects of the front surface treatment layer. Further, the reflecting plate for the Fresnel lens more properly reflects light, which is emitted in any other direction than the direction of the Fresnel lens out of light emitted from the light source, toward the Fresnel lens and efficiently directs light emitted from the light source to the Fresnel lens.

(9) In the first aspect, one of white-colored paint application and aluminum deposition is subjected to a front surface treatment layer on the concave reflecting surface for increasing the reflectance.

The reflecting plate for the Fresnel lens according to this aspect receives light emitted from the light source at the concave reflecting surface having one of the white-colored paint coating and the aluminum deposition applied thereto and reflects the same in a prescribed direction with a high reflectance through the light reflecting effects of the front surface treatment layer. Further, the reflecting plate more properly reflects light, which is emitted in any other direction than the direction of the Fresnel lens out of light emitted from the light source, toward the Fresnel lens and efficiently directs light emitted from the light source to the Fresnel lens. Note that the front surface treatment layer of the reflecting plate for the Fresnel lens according to this aspect may be recognized as the front surface layer described in the above (7). In this case, the substrate layer does not require a high reflectance. Therefore, it is possible to allow more selectabilities for materials and to provide additional function to the substrate layer besides reflectance properties.

(10) An illumination device according to a second aspect includes the reflecting plate for the Fresnel lens described in the above (1) to (9).

(11) In the second aspect, the illumination device further includes a light source made of a solid light emitting element.

Further, the illumination device according to the above (10) and (11) provides the operations corresponding to the reflecting plate for the Fresnel lens of the above (1) to (9). Note that, besides the COB type LED exemplified in the above (2), it is possible to employ a solid light emitting element in any fowl such as an LED, a semiconductor laser, and an organic EL.

Since the present invention is structured as described above, it is possible to prevent deterioration in appearance of an illumination device using a Fresnel lens while optimizing irradiation light.

### BRIEF DESCRIPTION OF THE DRAWINGS

FIGS. 1A to 1C show a reflecting plate for a Fresnel lens according to an embodiment of the present invention, FIG. 1A being a perspective view of the reflecting plate for the Fresnel lens on the front surface side, FIG. 1B being a perspective view of the reflecting plate for the Fresnel lens on the rear surface side, and FIG. 1C being a cross-sectional view of the reflecting plate for the Fresnel lens.

FIGS. 2A and 2B are exploded views of an illumination device having the reflecting plate for the Fresnel lens according to the embodiment of the present invention, FIG. 2A being a perspective view of the illumination device on the front surface side, and FIG. 2B being a perspective view of the illumination device on the rear surface side.

FIG. 3 is a partial perspective view as seen from the rear surface side of the substantial parts of the illumination device shown in FIGS. 2A and 2B.

FIGS. 4A to 4C show the substantial parts of the illumination device shown in FIGS. 2A and 2B, FIG. 4A being a perspective view of the illumination device on the front surface side, FIG. 4B being a perspective view of the illumination device on the rear surface side, and FIG. 4C being a cross-sectional view of the illumination device.

FIG. 5 is a graph in which an optical efficiency of the illumination device shown in FIGS. 2A and 2B is compared with an optical efficiency where an LED alone is taken into consideration and an optical efficiency where the reflecting plate is excluded from the illumination device.

FIGS. 6A to 6C show an illumination device using an LED as a light source, FIG. 6A being a side view of the illumination device, FIG. 6B being a cross-sectional view of the illumination device taken along the line B-B in FIG. 6A, and FIG. 6C being a cross-sectional view of the illumination device taken along the line A-A in FIG. 6A.

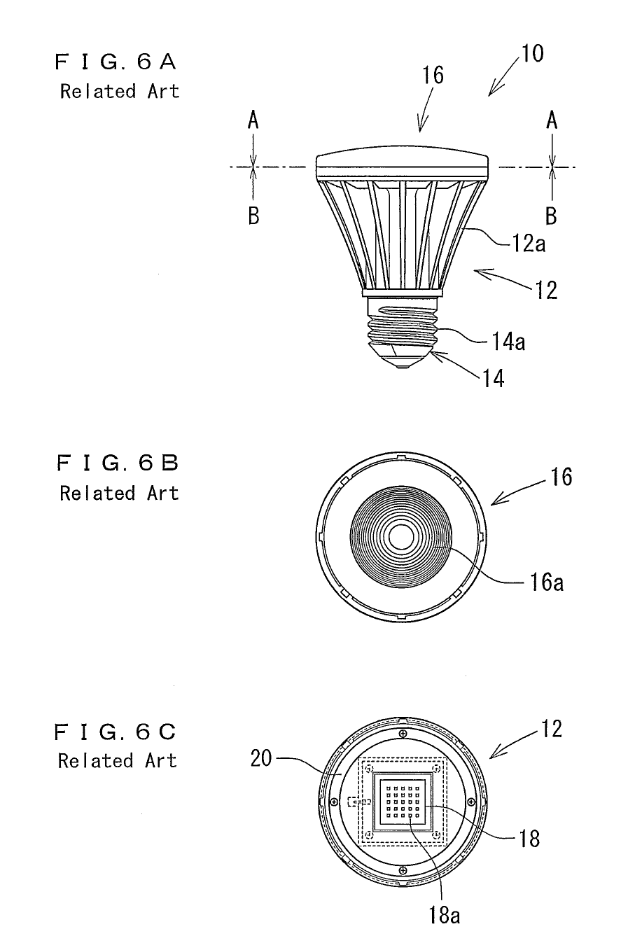

### DETAILED DESCRIPTION OF THE PREFERRED EMBODIMENTS

Hereinafter, each embodiment of the present invention will be described with reference to the drawings. Here, the same or equivalent parts to the related art will be denoted by the same symbols, and their detailed descriptions will be omitted.

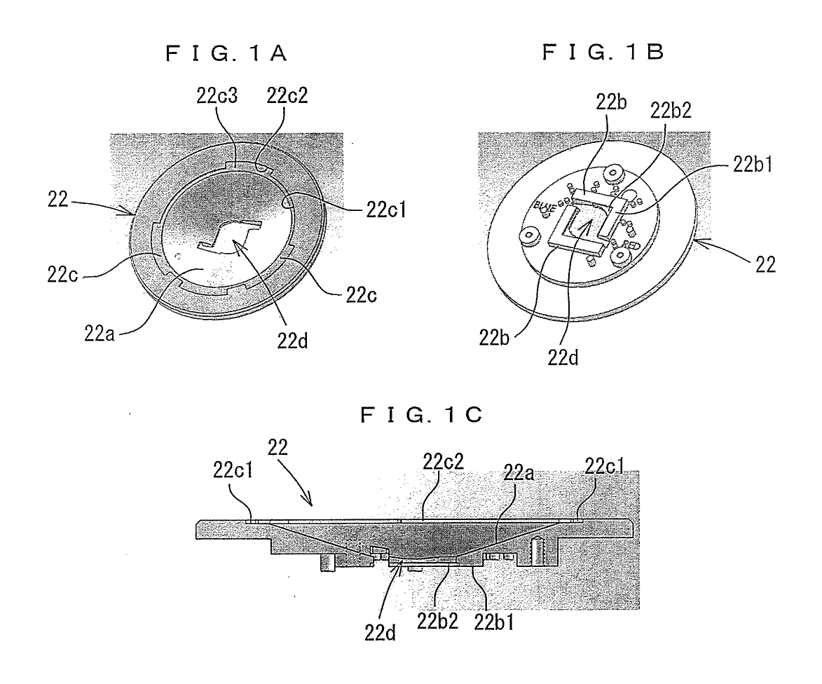

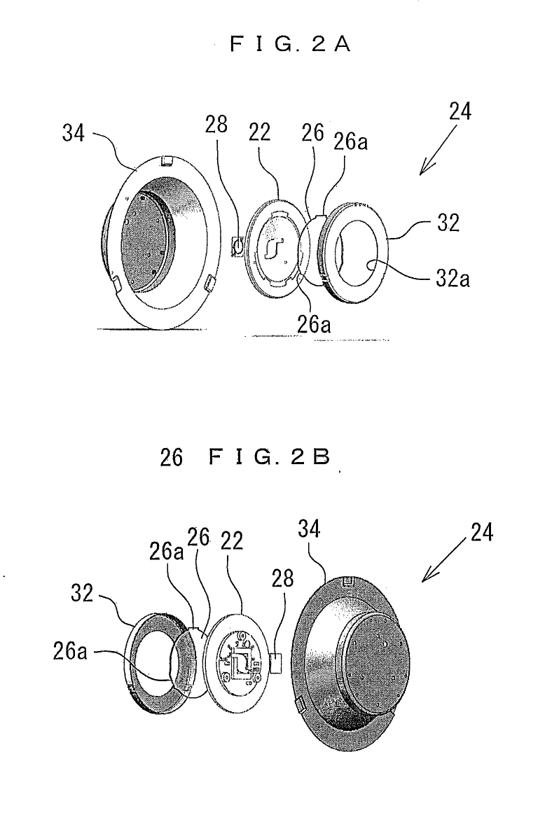

FIGS. 1A to 1C show a reflecting plate 22 for a Fresnel lens (hereinafter simply referred to as the reflecting plate 22) according to the embodiment of the present invention. FIGS. 2A and 2B to FIGS. 4A to 4C show an illumination device 24 having the reflecting plate 22 in FIG. 1A to 1C.

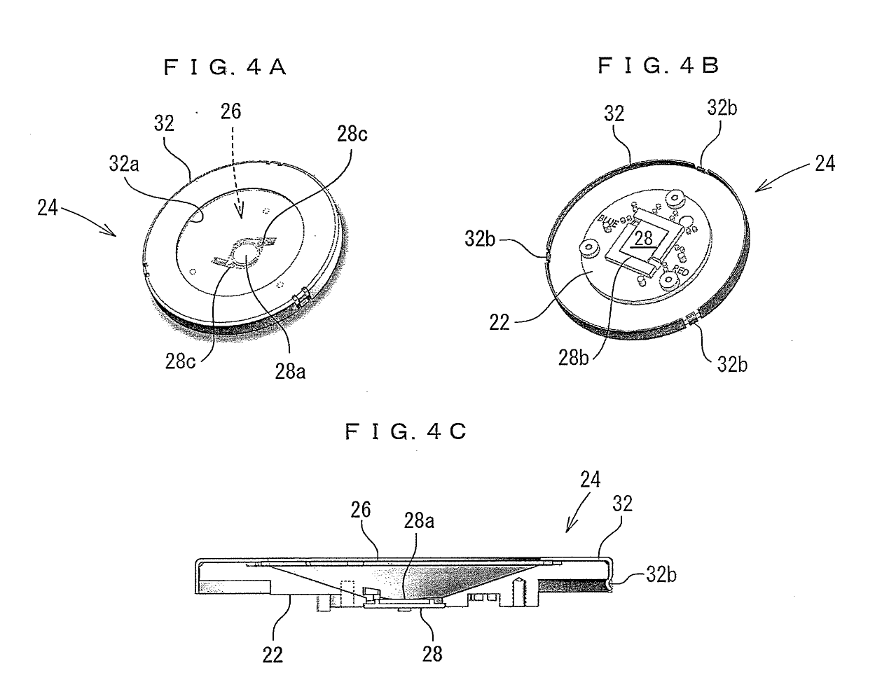

As shown in FIGS. 2A and 2B and FIGS. 4A to 4C, the reflecting plate 22 according to the embodiment of the present invention is arranged between a Fresnel lens 26 and a light source 28. The reflecting plate 22 has a concave reflecting surface 22a (FIGS. 1A to 1C) made of a cone-shaped curved surface to reflect light emitted from the light source 28 toward the Fresnel lens 26. The concave reflecting surface 22a is formed into a shape most suitable to reflect light emitted from the light source 28 toward the Fresnel lens 26. In addition, as shown in FIG. 1B, the reflecting plate 22 has a unit 22b to position the light source 28 (hereinafter simply referred to as the unit 22b) on the bottom of the concave reflecting surface 22a. Moreover, as shown in FIG. 1A, the reflecting plate 22 has a unit 22c to position the Fresnel lens 26 (hereinafter simply referred to as the unit 22c) at the open end thereof on a side opposite to the bottom of the concave reflecting surface 22a.

In an example shown in the figures, a COB type LED is used as the light source 28. Further, in the bottom of the concave reflecting surface 22a, the reflecting plate 22 has an opening 22d to allow light emitted from a light emitting part 28a (see FIG. 4A) of the COB type LED serving as the light source 28 to pass through. The unit 22b is formed on the surface of the bottom of the concave reflecting surface 22a on a side opposite to a side where the Fresnel lens 26 is arranged as shown in FIG. 1A, i.e., on the rear surface of the reflecting plate 22 as shown in FIG. 1B so as to surround the opening 22d. In addition, the unit 22b has concave and convex portions (including convex parts 22b1 and concave parts 22b2) having respective concave and convex configurations complementary to the outer shape of the light source 28. The concave and convex portions are made contactable with the light source 28.

In the example shown in the figures, the opening 22d is formed into a shape such that the light emitting part 28a of the COB type LED and electrodes 28c (FIG. 4A) provided in a ceramic substrate 28b (see FIG. 4B) constituting the COB type LED are exposed to the side (the front surface) of the reflecting plate 22 where the Fresnel lens 26 is arranged and that the insertion of a copper wire 30 soldered to the electrodes 28c to the rear surface of the reflecting plate 22 is made possible.

Further, the convex parts 22b1 of the unit 22b to position the light source 28 shown in FIG. 1B are frames having respective complementary shapes surrounding the outer shape (square) of the ceramic substrate 28b (see FIG. 4B) constituting the COB type LED. In this example, the convex parts 22b1 are configured to have a dimension in which the convex parts 22b1 allow being smoothly press-fitted in the ceramic substrate 28b. In addition, the concave parts 22b2 of the unit 22b to position the light source 28 are plane surfaces to which the front surface of the ceramic substrate 28b having the light emitting part 28a and the electrodes 28c closely adheres.

Moreover, the unit 22c has concave and convex portions (including convex parts 22c1, concave parts 22c2, and a plane surface part 22c3) having respective concave and convex configurations complementary to the outer shape of the Fresnel lens 26 (see FIGS. 2A and 2B). The concave and convex portions are made contactable with the Fresnel lens 26 so as to surround the open end (shown in FIG. 1A) on the side opposite to the bottom of the concave reflecting surface 22a.

In the example shown in FIGS. 2A and 2B, arc-shaped positioning collar parts 26a protrude from part of the periphery of the Fresnel lens 26. Further, the concave parts 22c2 of the unit 22c are made contactable with the positioning collar parts 26a of the Fresnel lens 26, while the convex parts 22c1 are made contactable with the periphery other than the positioning collar parts 26a of the Fresnel lens 26. The plane surface part 22c3 of the unit 22c is a part to which the front surface of the Fresnel lens 26 closely adheres and is formed to have a gap corresponding to the thickness of the Fresnel lens 26 at the open end of the concave reflecting surface 22a of the reflecting plate 22.

Furthermore, in a condition that the Fresnel lens 26 is positioned with the reflecting plate 22, a front cover 32 having an opening 32a to expose the Fresnel lens 26 is attached from the open end (shown in FIG. 1A) of the concave reflecting surface 22a of the reflecting plate 22 as shown in FIGS. 2A and 2B and FIGS. 4A to 4C. The front cover 32 is made of sheet metal in the example shown in the figures, but may be made of a synthetic resin or the like with request. In addition, as shown in FIGS. 4B and 4C, the front cover 32 has fitting claws 32b to be fit in the outer peripheral ends of the reflecting plate 22.

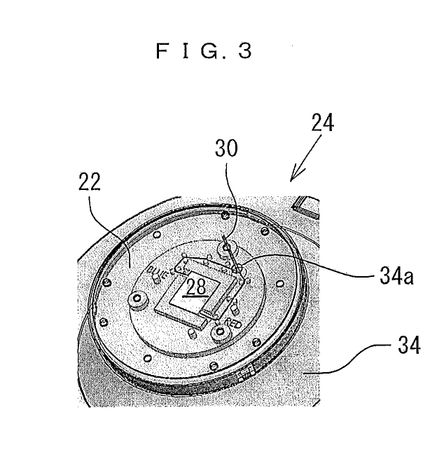

The reflecting plate 22 having the front cover 32 fixed thereto is fixed to a rear cover 34 shown in FIGS. 2A and 2B to complete the assembly of the illumination device 24. The rear cover 34 is made of sheet metal in the example shown in the figures, but may be made of a synthetic resin or the like provided that measures against heat radiation are individually considered with request. Note that as shown in FIG. 3, the copper wire 30 soldered to the electrodes 28c of the light source 28 is guided to the rear surface side of the reflecting plate 22 and distributed to the outside of the illumination device 24 via a copper wire hole 34a of the rear cover 34.

According to the embodiment of the present invention thus structured, the following functions and effects are obtainable.

The reflecting plate 22 according to the embodiment of the present invention makes it possible to reflect light, which is emitted in any other direction than the direction of the Fresnel lens 26 out of light emitted from the light source, toward the Fresnel lens 26 with the concave reflecting surface 22a of the reflecting plate 22 arranged between the Fresnel lens 26 and the light source 28. The reflecting plate 22 allows light emitted from the light source 28 efficiently to direct toward the Fresnel lens 26.

In addition, the light source 28 and the Fresnel lens 26 are respectively positioned by the unit 22b provided on the bottom of the concave reflecting surface 22a and the unit 22c provided at the open end on the side opposite to the bottom of the concave reflecting surface 22a. That is, the light source 28 and the Fresnel lens 26 are positioned via the reflecting plate 22 to make the light axis of the Fresnel lens 26 and that of light emitted from the light source 28 exactly correspond to each other.

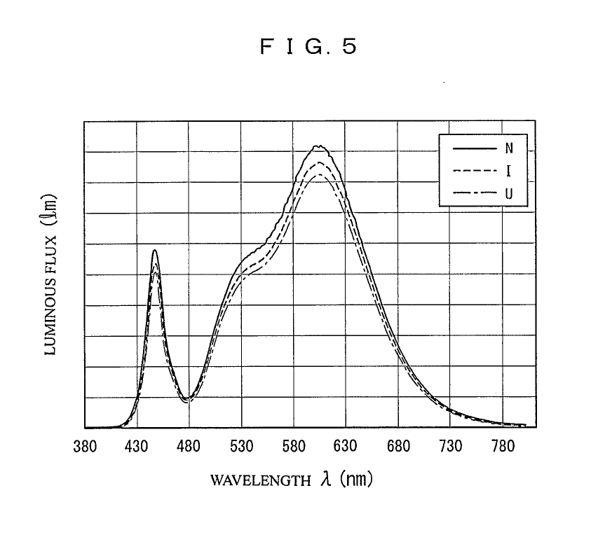

FIG. 5 is a graph in which an optical efficiency I of the illumination device 24 having the reflecting plate 22 according to the embodiment of the present invention is compared with an optical efficiency N where a light source alone is taken into consideration and an optical efficiency U where the reflecting plate 22 is excluded.

It is clear from the graph of FIG. 5 that, if the optical efficiency N where the light source alone is taken into consideration is 100.0%, the optical efficiency U of the illumination device excluding the reflecting plate 22 is 89.3% and the optical efficiency I of the illumination device 24 according to the embodiment of the present invention is 93.5%. That is, although the Fresnel lens 26 absorbs the emitted light to cause a reduction in the amount of light (U) compared with the case where the light source 18 alone is taken into consideration (N), the use of the reflecting plate 22 according to the embodiment of the present invention results in an improvement (recovery) in the optical efficiency by 4.2% (I). Note that just for reference, a total luminous flux in each comparative example is 919.0 (lm) for the case where the light source alone is taken into consideration, 821.0 (lm) for the case where the illumination device excludes the reflecting plate 22, and 859.0 (lm) for the case of the illumination device 24 according to the embodiment of the present invention under the same measurement conditions.

In addition, the reflecting plate 22 has the opening 22d allowing light emitted from the light source 28 to pass through in the bottom of the concave reflecting surface 22a, and the unit 22b is arranged to position the light source 28 on the surface of the bottom of the concave reflecting surface 22a on the side opposite to the side where the Fresnel lens 26 is arranged. That is, it is possible to position the light source 28 with respect to the reflecting plate 22 with the concave and convex portions (including the convex parts 22b1 and the concave parts 22b2) having the respective concave and convex configurations complementary to the outer shape of the light source 28. The concave and convex portions are made contactable with the light source 28 so as to surround the opening 22d on the surface of the bottom of the concave reflecting surface 22a on the side opposite to the side where the Fresnel lens 26 is arranged.

As described in the embodiment of the present invention, if the COB type LED is used as the light source 28, the concave and convex portions (including the convex parts 22b1 and the concave parts 22bs) having the respective concave and convex configurations complementary to the outer shape of the ceramic substrate 28b constituting the COB type LED are formed to surround the opening 22d on the surface of the bottom of the concave reflecting surface 22a on the side opposite to the side where the Fresnel lens 26 is arranged. In addition, in the embodiment of the present invention, the concave and convex portions (including the convex parts 22b1 and the concave parts 22b2) are the frames having a dimension that allows being smoothly press-fitted into the ceramic substrate 28b. Thus, the light source 28 is positioned with respect to the reflecting plate 22 and temporarily fixed to the reflecting plate 22 at the same time. Moreover, since the reflecting plate 22 is made of a non-transparent material, inner wiring such as the copper wire 30 is covered and prevented from being seen through via the Fresnel lens 26 from an outside, which makes it possible to prevent deterioration of appearance in the illumination device 24.

In the embodiment of the present invention, it is described that the unit 22b has a dimension that allows being smoothly press-fitted into the outer shape of the ceramic substrate 28b constituting the COB type LED serving as the light source 28. However, even if the unit 22b is loosely fitted into the outer shape of the ceramic substrate 28b, the light source 28 is held and fixed between the reflecting plate 22 and the rear cover 34, which causes no problem in the assembly or the like.

On the other hand, the unit 22c is arranged at the position, at which the open end on the side opposite to the bottom of the concave reflecting surface 22a is surrounded, to position the Fresnel lens 26. That is, it is possible to position the Fresnel lens 26 with respect to the reflecting plate 22 with the concave and convex portions (including the convex parts 22c1, the concave parts 22c2, and the plane surface part 22c3) having the respective concave and convex configurations complementary to the outer shape of the Fresnel lens 26. The concave and convex portions are made contactable with the Fresnel lens 26 so as to surround the open end on the side opposite to the bottom of the concave reflecting surface 22a.

In the embodiment of the present invention, the arc-shaped positioning collar parts 26a protrude from part of the periphery of the Fresnel lens 26, and the concave reflecting surface 22a has the respective concave and convex configurations complementary to the outer shape of the Fresnel lens 26 to surround the open end on the side opposite to the bottom thereof. In addition, in the embodiment of the present invention, since the concave and convex portions (including the convex parts 22c1, the concave parts 22c2, and the plane surface part 22c3) are formed into the frames having approximately the same dimensional relationship as the outer shape of the Fresnel lens 26, it is possible to exactly position the Fresnel lens 26 with respect to the reflecting plate 22.

Thus, the light source 28 and the Fresnel lens 26 are positioned via the reflecting plate 22, that can make the light axis of the Fresnel lens 26 and that of light emitted from the light source 28 exactly correspond to each other.

Moreover, the reflecting plate 22 according to the embodiment of the present invention is made of a material having a reflectance of 85% or more. Therefore, with the reception of light emitted from the light source 28 at the concave reflecting surface 22a, it is possible for the reflecting plate 22 to reflect light in a prescribed direction with a high reflectance. Further, the reflecting plate 22 more properly reflects light emitted from the light source 28 toward the Fresnel lens 26 while preventing the leakage of light emitted in any other direction than the direction of the Fresnel lens 26 out of light emitted from the light source. Thus, it is possible for the reflecting plate 22 to efficiently direct light emitted from the light source 28 to the Fresnel lens 26.

As a material having such a high reflectance, a polycarbonate resin or an ABS resin is used. In particular, a white-colored resin is suitable to improve the reflectance. Further, with the use of such materials, it is possible to manufacture the reflecting plate 22 at low cost by, for example, an ejection molding.

Hereinafter, although not shown in the figures, an applied example of the reflecting plate 22 according to the embodiment of the present invention will be described.

First, it is also possible to provide, on the concave reflecting surface 22a of the reflecting plate 22, a reflecting direction adjustment unit to reflect light emitted from the light source 28 in a prescribed direction. Examples of the reflecting direction adjustment unit include a prism. Light emitted from the light source 28 is received at the concave reflecting surface 22a and then reflected in a prescribed direction by the reflecting direction adjustment unit (for example, the front surface of a prism) provided on the concave reflecting surface 22a. In this case, compared with the concave reflecting surface 22a composed of a curved surface or an inclined surface on which no concave and convex configuration is intentionally provided, the concave reflecting surface 22 can more properly reflect light, which is emitted in any other direction than the direction of the Fresnel lens 26 out of light emitted from the light source, toward the Fresnel lens 26 with the reflecting direction adjustment unit. Then, by harmonizing the reflecting effects of light with the reflecting direction adjustment unit and the polarizing operation of the Fresnel lens 26, it is possible to adjust the desired distribution of light and further improve (optimize) the optical efficiency.

Here, the reflecting plate 22 may have a front surface layer made of a material having a high reflectance and a substrate layer made of a material different from that of the front surface layer. In this case, it is possible to receive light emitted from the light source 28 at the concave reflecting surface 22a through materials having a high reflectance constituting the front surface layer. The concave reflecting surface 22a then allows reflecting light in a prescribed direction with the high reflectance through the reflecting effects of light. In addition, with the substrate layer made of a material different from that of the front surface layer, it is possible to assure the strength of the reflecting plate 22. In this case, the substrate layer does not require a high reflectance. Therefore, it is possible to allow more selectabilities for materials and to provide additional function to the substrate layer besides a reflectance properties.

For example, the substrate layer serving as a frame including the unit to position the light source 28 or the unit to position the Fresnel lens 26 may be made of a synthetic resin such as a polycarbonate resin and an ABS resin. Further, it is possible to employ a two-layer structure in which the front surface layer having an aluminum plate or the like fixed thereto is integrated to cover the substrate layer. In addition, in order to improve the strength of the reflecting plate 22, it is possible to employ a three-layer structure in which a metal layer serving as the substrate layer is embedded inside the front surface layer made of a synthetic resin. Moreover, in order to efficiently radiate heat from the light source 28 via the reflecting plate 22, it is possible to employ a multi-layer structure having a heat radiation layer. Further, it is possible to appropriately select any of these multi-layer structures in consideration of the size, thickness, weight, strength, wall thickness, radiation performance, or the like of the reflecting plate 22.

In addition, a surface treatment may be applied to the concave reflecting surface 22a of the reflecting plate 22 to increase the reflectance. Thus, it is possible to receive light emitted from the light source 28 at the concave reflecting surface 22a and reflect the same in a prescribed direction with a high reflectance. Further, the concave reflecting surface 22a can more properly reflect light, which is emitted in any direction other than the direction of the Fresnel lens 26 out of light emitted from the light source, toward the Fresnel lens 26. The concave reflecting surface 22a with the surface treatment will then more efficiently direct light toward the Fresnel lens 26.

In addition, in order to form a front surface treatment layer to increase the reflectance of the concave reflecting surface 22a of the reflecting plate 22, white-colored paint application or aluminum deposition is, for example, performed. Note that the front surface treatment layer of the reflecting plate 22 may be recognized as the front surface layer of each of the multi-layer structures described above. In this case, the substrate layer does not require a high reflectance and may be made of a transparent material. Therefore, it is possible to allow more selectabilities for materials and to provide additional function to the substrate layer besides reflectance properties.

Moreover, as the light source 28, it is possible to employ a solid light emitting element in any form such as an LED, a semiconductor laser, and an organic EL besides the COB type LED.

1. A reflecting plate for a Fresnel lens arranged between the Fresnel lens and a light source, the reflecting plate comprising:
a concave reflecting surface to reflect light emitted from the light source toward the Fresnel lens;
a unit to position the light source, the unit being provided at a bottom of the concave reflecting surface; and
a unit to position the Fresnel lens, the unit being provided at an open end on a side opposite to the bottom of the concave reflecting surface.

2. The reflecting plate for the Fresnel lens according to claim 1, the reflecting plate further comprising:
an opening formed in the bottom of the concave reflecting surface to allow light emitted from the light source to pass through, wherein
the unit to position the light source has concave and convex portions having respective concave and convex configurations complementary to an outer shape of the light source and contactable with the light source so as to surround the opening, the concave and convex portions being arranged on a surface of the bottom of the concave reflecting surface on a side opposite to a side where the Fresnel lens is arranged, and
the unit to position the Fresnel lens has concave and convex portions having respective concave and convex configurations complementary to an outer shape of the Fresnel lens and contactable with the Fresnel lens so as to surround the open end on the side opposite to the bottom of the concave reflecting surface.

3. The reflecting plate for the Fresnel lens according to claim 1, wherein the concave reflecting surface has a reflecting direction adjustment unit to reflect light emitted from the light source in a prescribed direction.

4. The reflecting plate for the Fresnel lens according to claim 3, wherein the reflecting direction adjustment unit is a prism.

5. The reflecting plate for the Fresnel lens according to claim 1, wherein the reflecting plate is made of a material having a high reflectance.

6. The reflecting plate for the Fresnel lens according to claim 1, wherein the material having the high reflectance is one of a polycarbonate resin and an ABS (Acrylonitrile Butadiene Styrene) resin.

7. The reflecting plate for the Fresnel lens according to claim 5, the reflecting plate further comprising: a front surface layer made of a material having the high reflectance; and a substrate layer made of a material different from the material of the front surface layer.

8. The reflecting plate for the Fresnel lens according to claim 1, wherein a surface treatment is applied to the concave reflecting surface for increasing the reflectance.

9. The reflecting plate for the Fresnel lens according to claim 8, wherein one of white-colored paint application and aluminum deposition is subjected to a front surface treatment layer on the concave reflecting surface for increasing the reflectance.

10. An illumination device, comprising: the reflecting plate for the Fresnel lens according to claim 1.

11. The illumination device according to claim 10, further comprising: a light source made of a solid light emitting element.
